(19) United States
(12) Patent Application Publication
(10) Pub. No.: US 2016/0108971 A1
(43) Pub. Date: Apr. 21, 2016

(54) CLUTCH RELEASE BEARING DEVICE, NOTABLY FOR MOTOR VEHICLE CLUTCHES

(71) Applicant: Benoit Arnault, Saint-Cyr-sur-Loire (FR)

(72) Inventor: Benoit Arnault, Saint-Cyr-sur-Loire (FR)

(73) Assignee: Aktiebolaget SKF, Goteborg (SE)

(21) Appl. No.: 14/515,235

(22) Filed: Oct. 15, 2014

(51) Int. Cl. F16D 23/14

(52) U.S. Cl. CPC F16D 23/14

(57) ABSTRACT

A clutch release bearing device including a rolling bearing having an interior race, an exterior race, at least one row of rolling elements mounted between the races, and two seals disposed radially between the interior and exterior races and on either axial side of the rolling elements is provided. The release bearing device further includes a bearing ring that bears axially on one of the races and an actuating ring bearing axially on the other race The clutch release bearing device provides at least one additional sealing member that is positioned outside the rolling bearing and bears axially against one of the interior and exterior races and cooperates with the other one of the interior and exterior races or with the bearing ring.

### FIELD OF THE INVENTION

The present invention relates to the field of clutch release bearing devices intended to act on the diaphragm of a clutch, in particular for motor vehicles, notably for Lorries.

### BACKGROUND OF THE INVENTION

A clutch release bearing device generally includes a rolling bearing one of the races of which turns and the other of which is fixed, the race that turns having a radial bearing surface intended to come into contact with the ends of the fingers constituting the diaphragm of the clutch. Between the turning race and the fixed race there are disposed rolling elements regularly spaced in the circumferential direction by a cage. The interior and exterior races are generally of a thin-wall type and may advantageously be produced by pressing a steel plate or tube.

A non-turning maneuvering element supports the rolling bearing and, when acted on by a (mechanical, electrical or hydraulic) driving member, moves the bearing axially to cause the bearing surface of the turning race to press against the diaphragm of the clutch and actuate the clutch mechanism.

Under some operating conditions the sealing of this rolling bearing may prove insufficient.

In order to address present-day requirements for the use of clutches on particularly dusty roads, it is necessary to strengthen the sealing of present-day clutch release bearing devices.

The present invention aims to remove this drawback.

### SUMMARY OF THE INVENTION

The present invention more particularly aims to provide a clutch release bearing device of low cost, having improved sealing and that is simple to manufacture and to assemble.

In one embodiment, a clutch release bearing device includes a rolling bearing including an interior race, an exterior race, at least one row of rolling elements mounted between said races, and two seals disposed radially between the interior and exterior races and on either axial side of the rolling elements. The release bearing device includes a bearing ring bearing axially on one of the races of the rolling bearing and an actuating ring bearing axially on the other race of the rolling bearing.

The clutch release bearing device includes at least one additional sealing member situated outside the rolling bearing and bearing axially against one of the interior or exterior races and cooperating with the other race or with the bearing ring, so as to form a seal on the upstream side of the seal inside the rolling bearing.

In one embodiment, the clutch release bearing device includes a flange for axially retaining the exterior race and the actuating ring. The axial retention flange advantageously includes an axial portion in radial contact with the exterior race and the actuating ring, a first radial rim in axial contact with the exterior race and a second radial rim in axial contact with the actuating ring.

In one embodiment, the additional sealing member includes a first edge fixed axially between the exterior race and the axial retention flange and a second edge cooperating with the interior race.

In another embodiment, the additional sealing member includes a first edge fixed axially between the exterior race and the axial retention flange and a second edge cooperating with the bearing ring.

For example, the second edge of the additional sealing member is of a rubbing type.

In another embodiment, the clutch release bearing device includes a second additional sealing member situated outside the rolling bearing and bearing axially against one of the interior or exterior races and cooperating with the other race.

The second additional sealing member advantageously includes a first edge fixed axially between the exterior race and the actuating ring and a second edge cooperating with the interior race.

For example, the second edge of the second additional sealing member is of a rubbing type.

The interior and exterior races of the rolling bearing may be of a solid type.

### BRIEF DESCRIPTION OF THE DRAWINGS

The present invention will be better understood on studying the detailed description of embodiments given by way of nonlimiting example and illustrated by the appended drawings, in which:

FIG. 1 is a half-view in axial section of a clutch release bearing device in accordance with a first embodiment;

FIG. 2 is another half-view in axial section of the clutch release bearing device from FIG. 1;

FIG. 3 is a half-view in axial section of a clutch release bearing device in accordance with a second embodiment; and

FIG. 4 is another half-view in axial section of the clutch release bearing device from FIG. 3.

### DETAILED DESCRIPTION OF THE INVENTION

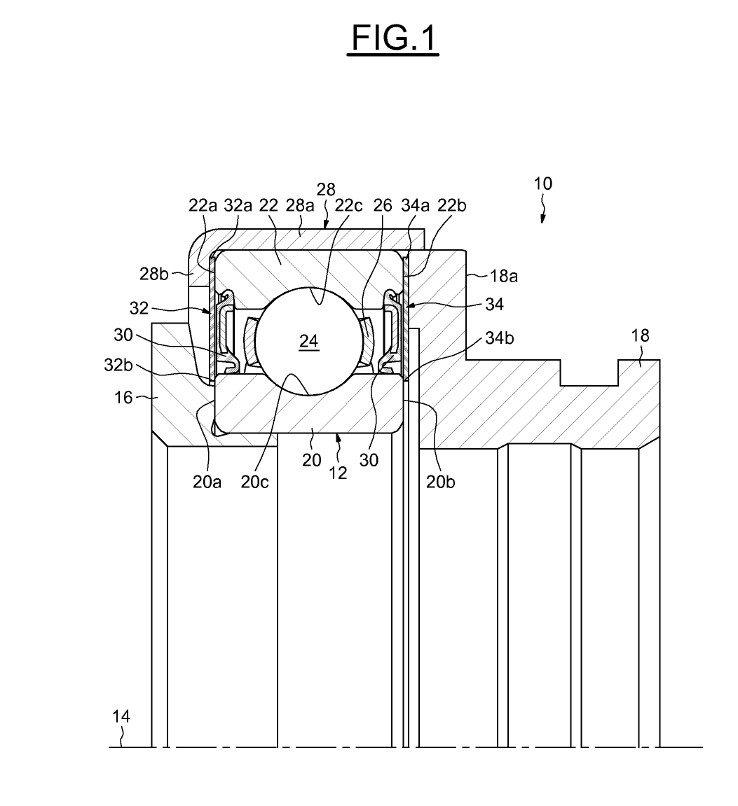

In FIG. 1, a clutch release bearing device 10 is intended to act on the diaphragm of a clutch, in particular for a motor vehicle, and primarily includes a rolling bearing 12, with rotation axis 14, a bearing or wear ring 16 intended to cooperate through contact with a diaphragm (not represented), and an actuating ring 18 intended to be actuated by a driving member (not represented), such as a driving fork, for example.

The rolling bearing 12 comprises an interior race 20 that turns, a non-turning exterior race 22, a row of rolling elements 24, here taking the form of balls, and mounted between said races, and a cage 26 for maintaining the regular circumferential spacing of the rolling elements. The interior and exterior races 20, 22 are of the solid type in order to produce a clutch release bearing device of low cost.

Each of the interior and exterior races 20, 22 includes two radial lateral surfaces 20a, 20b, 22a, 22b and a toroidal surface 20c, 22c having in cross section a concave quarter-circle internal profile forming a torus-shaped rolling track or raceway for the rolling elements 24.

The bearing ring 16 is for actuating a clutch mechanism, for example the end of the radial fingers of a diaphragm (not represented), and is adapted to reduce friction with the diaphragm and to accommodate defects in the angular alignment between the axis of the rolling bearing and the axis of the diaphragm. The bearing ring 16 is disposed so as to bear axially against a radial surface 20a of the interior race 20.

The actuating ring 18 is disposed so as to bear axially against a radial surface 22b of the exterior race 22 situated on the opposite side to the bearing ring 16.

The clutch release bearing device 10 also includes an axial retention flange 28 including an axial portion 28a and two radial rims 28b, 28c enabling axial retention of the actuating ring 18 and the rolling bearing 12.

The interior surface of the axial portion 28a of the flange 28 is in radial contact with the cylindrical exterior surface of the exterior race 22 and the cylindrical exterior surface of the actuating ring 18. A first radial rim 28b extends radially inwards from the axial portion 28a and is in axial contact with a radial surface 22a of the exterior race 22. A second radial rim 28c extends radially inwards from the axial portion 28a and is in axial contact with a radial lateral surface 18a of the actuating ring 18.

The rolling bearing 12 also includes two sealing members 30 radially mounted in a sealed manner between the interior race 20 and the exterior race 22 and on either axial side of the rolling elements 24. The sealing members 30 may for example be of the type including a flexible portion having one edge 30a fixed to the exterior race 22 and a second edge 30b in contact with the cylindrical exterior surface of the interior race 20. The sealing members 30 could include a metal armature. Alternatively, any other type of sealing member could be provided between the interior and exterior races of the rolling bearing.

The clutch release bearing device 10 includes additional sealing members 32, 34.

The first additional sealing member 32 includes a first edge 32a fixed axially between a radial surface 22a of the exterior race 22 and the first radial rim 28b of the flange 28 and a second edge 32b rubbing against the interior race 20.

Such a sealing member makes it possible to form a seal on the upstream side of the seal 30 of the rolling bearing 12 and thus to close off the radial space existing between the flange 28 and the bearing ring 16.

The second additional sealing member 34 includes a first edge 34a fixed axially between a radial surface 22b of the exterior race 22 and the actuating ring 18 and a second edge 34b rubbing against the interior race 20.

Such a sealing member makes it possible to form a seal on the upstream side of the seal 30 of the rolling bearing 12 and thus to close off the radial space existing between the flange 28 and the actuating ring 18. As shown, the additional sealing members 32, 34 are produced in one piece from a synthetic material, such as rubber or a polymer material, for example.

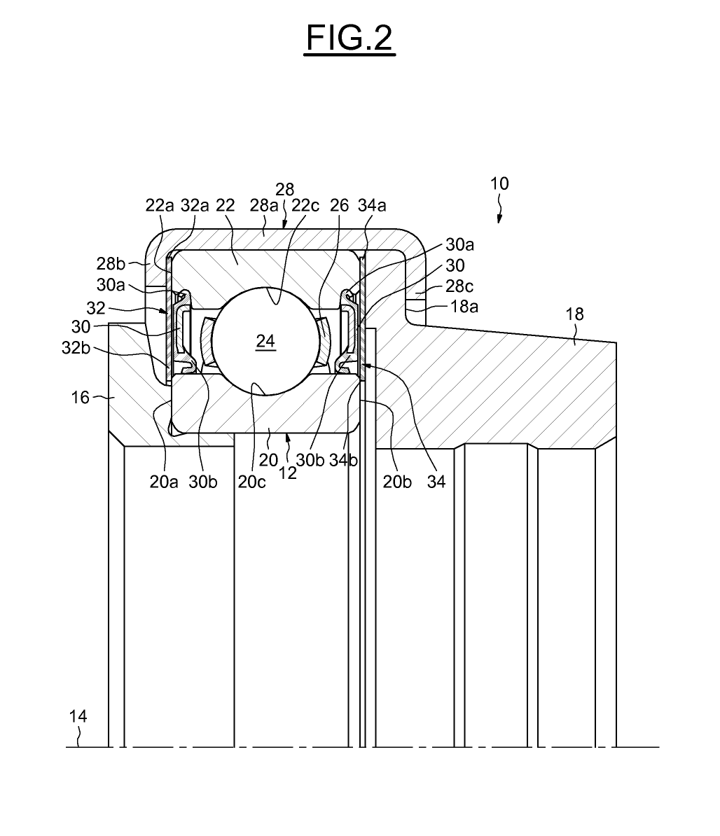

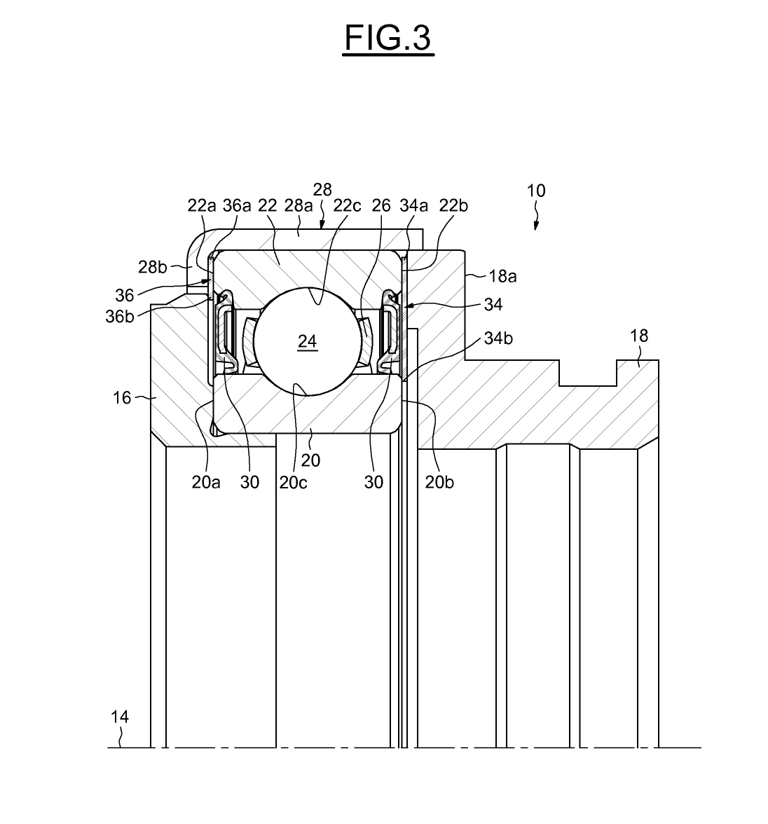

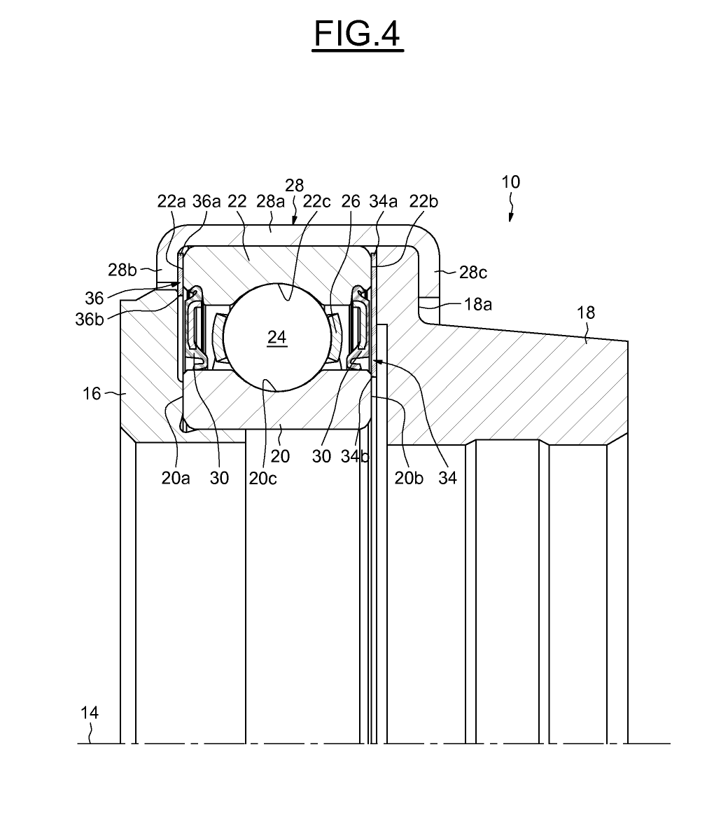

The embodiment shown in FIGS. 3 and 4, in which identical elements bear the same references, differs from the embodiment shown in FIGS. 1 and 2 only in that the first sealing member 36 includes a first edge 36a fixed axially between a radial surface 22a of the exterior race 22 and the first radial rim 28b of the flange 28 and a second edge 36b rubbing against the bearing ring 18.

For example, the first additional sealing member 36 is made in one piece from a synthetic material or a polymer material.

It will be noted that the additional sealing members may include a reinforcing metal armature.

It will be noted that in all the embodiments described the additional sealing members are additional elements separate from the axial retention flange.

Alternatively, the additional sealing members could be fixed between the interior race and the flange and the actuating ring, respectively. One of the additional sealing members could equally be fixed to the interior or exterior race and the other additional sealing member fixed to the other race.

Moreover, in the embodiments shown, the additional seals include an external sealing lip of a rubbing type. This lip could instead be a labyrinth lip.

1. A clutch release bearing device including a rolling bearing having an interior race, an exterior race, at least one row of rolling elements mounted between the races, and two seals disposed radially between the interior and exterior races and on either axial side of the rolling elements, the release bearing device having a bearing ring bearing axially on one of the interior and exterior races and an actuating ring bearing axially on the other one of the interior and exterior races, the clutch release bearing device comprising:
at least one additional sealing member disposed outside the rolling bearing and bearing axially against one of the interior and exterior races and cooperating with the other one of the interior and exterior races or with the bearing ring.

2. The clutch release bearing device according to claim 1, further comprising a flange for axially retaining the exterior race and the actuating ring.

3. The clutch release bearing device according to claim 2, wherein the additional sealing member is separate from the axial retention flange.

4. The clutch release bearing device according to claim 3, wherein the axial retention flange includes an axial portion in radial contact with the exterior race and the actuating ring, a first radial rim in axial contact with the exterior race and a second radial rim in axial contact with the actuating ring.

5. The clutch release bearing device according to claim 4, wherein the additional sealing member includes a first edge fixed axially between the exterior race and the axial retention flange and a second edge cooperating with the interior race.

6. The clutch release bearing device according to claim 4, wherein the additional sealing member includes a first edge fixed axially between the exterior race and the axial retention flange and a second edge cooperating with the bearing ring.

7. The clutch release bearing device according to claim 6, wherein the second edge of the additional sealing member is of a rubbing type.

8. The clutch release bearing device according to claim 1, further comprising a second additional sealing member situated outside the rolling bearing and bearing axially against one of the interior and exterior races and cooperating with the other one of the interior and exterior races.

9. The clutch release bearing device according to claim 8, wherein the second additional sealing member includes a first edge fixed axially between the exterior race and the actuating ring and a second edge cooperating with the interior race.

10. The clutch release bearing device according to claim 9, wherein the second edge of the second additional sealing member is of a rubbing type.

11. The clutch release bearing device according to claim 10, wherein the interior and exterior races of the rolling bearing are of a solid type.
